(19) United States
(12) Patent Application Publication
(10) Pub. No.: US 2014/0351620 A1
(43) Pub. Date: Nov. 27, 2014

(54) POWER SUPPLY DETECTING SYSTEM AND DETECTING METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: MING YU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/162,774

(22) Filed: Jan. 24, 2014

(30) Foreign Application Priority Data
May 23, 2013 (CN) 2013101945526

(51) Int. Cl. G06F 1/28

(52) U.S. Cl. CPC G06F 1/28
USPC 713/340

(57) ABSTRACT

A detecting system of a power supply includes a logic unit and a baseboard management controller. The logic unit is configured to receive a health state of a power supply. The baseboard management controller is electrically connected to the logic unit. The BMC is configured to detect the power input state of the power supply. After detecting the power input state of the power supply, the BMC is configured to transmit a signal to the logic unit, and the logic unit is configured to receive the health state of the power supply and send a feedback of the health state to the BMC after receiving the signal.

### FIELD

The disclosed embodiments relate generally to a detecting system of a power supply and a detecting method of a power supply.

### BACKGROUND

In a server, a power supply ready signal is used for detecting if an inserted Redundant Power System (RPS) is healthy. However, when a healthy RPS is inserted into a server without supplying power, a conventional detecting method may recognize the healthy RPS as a fail RPS.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a detecting system of a power supply in one embodiment.

FIG. 2 is a block view of a detecting method of a power supply in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

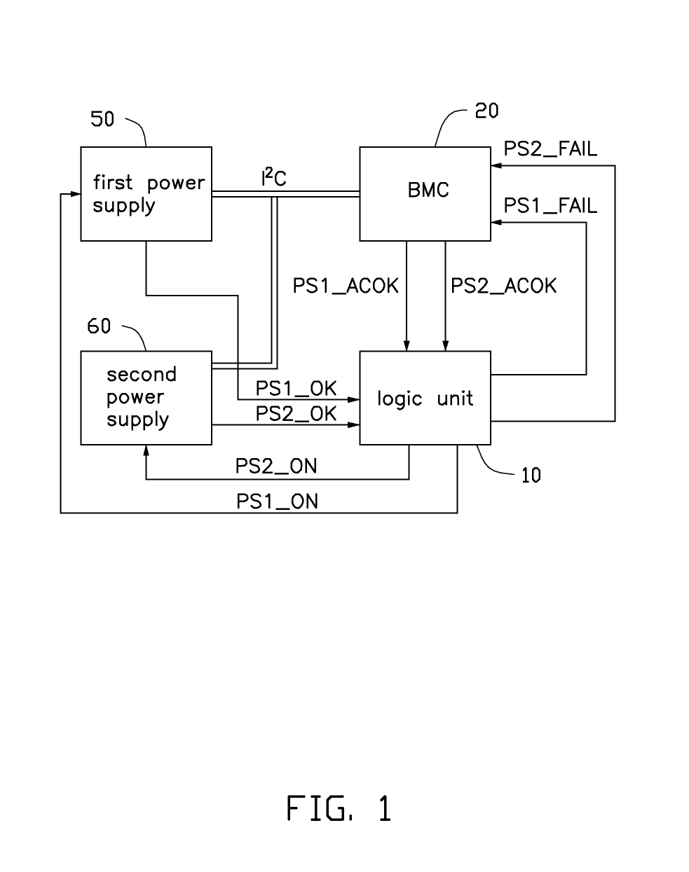

FIG. 1 is a block diagram illustrating a detecting system for a power supply in accordance with more than one embodiment. The detecting system can be used in a computer system. The detecting system includes a logic unit 10, a baseboard management controller (BMC) 20 connected to the logic unit 10. The logic unit 10 can be a complex programmable logic device (CPLD). The logic unit 10 and the BMC 20 are connected to a first power supply 50 and a second power supply 60. The first power supply 50 and the second power supply 60 may be (redundant power system) RPS power supplies. The BMC 20 connects the first power supply 50 and the second power supply 60 through an inter-integrated circuit (I²C) bus.

In use, the first power supply 50 is a working power supply, and the second power supply 60 is a backup power supply. When the second power supply 60 is inserted, the BMC 20 reads a power input signal from a register of the second power supply 60 through the I²C bus. The second power supply 60 can set a value to the register such as 1 or 0 to indicate if the second power supply 60 is powered. When the BMC 20 detects that no power is provided to the second power supply 60, the BMC 20 reports to an operation system the result. When the BMC 20 detects that the second power supply 60 is powered, the BMC 20 sends a PS_ACOK signal to the logic unit 10 to inform the logic unit 10 to detect a health state of the second power supply 60. The logic unit 10 starts to test the second power supply 60, and reads a PS_OK signal to indicate the health state of the second power supply 60 after a predefined time. The logic unit 10 informs of the health state of the second power supply 60 to the BMC 20 through a PS_FAIL signal after the logic unit 10 receives the PS_OK signal. The BMC 20 then informs an operation system about the health state of the second power supply 60.

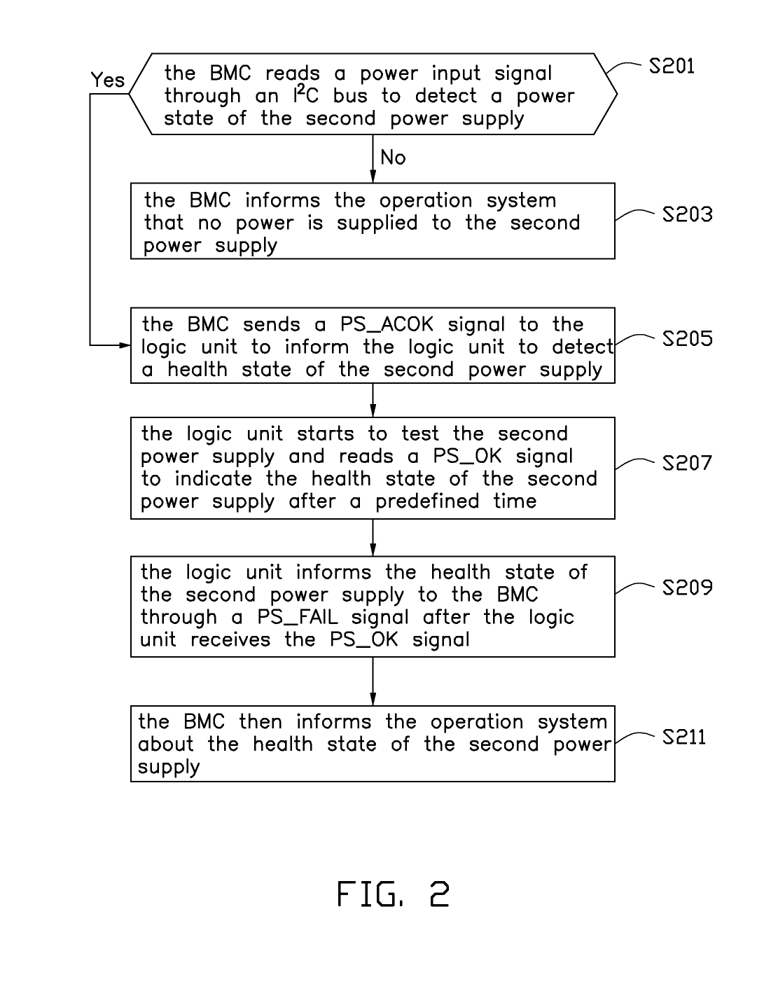

FIG. 2 illustrates a flowchart of a detecting method of a power supply. The detecting method includes the following blocks.

As illustrated in block S201, a power supply detecting block, the BMC 20 reads a power input signal from a register of the second power supply 60 through an I²C bus to detect a power state of the second power supply 60. When no power is detected, the steps go to block S203. When power is detected, the steps go to block 5205.

As illustrated in block S203, the BMC 20 informs the operation system that no power is supplied to the second power supply 60.

As illustrated in block S205, an informing block, the BMC 20 sends a PS_ACOK signal to the logic unit 10 to inform the logic unit 10 to detect a health state of the second power supply 60.

As illustrated in block S207, a health state detecting block, the logic unit 10 starts to test the second power supply 60 and reads a PS_OK signal to indicate the health state of the second power supply 60 after a predefined time.

As illustrated in block S209, a feedback block, the logic unit 10 informs the health state of the second power supply 60 to the BMC 20 through a PS_FAIL signal after the logic unit 10 receives the PS_OK signal.

As illustrated in block S211, the BMC 20 then informs the operation system about the health state of the second power supply 60.

It is to be understood, however, that even though numerous characteristics and advantages have been set forth in the foregoing description of embodiments, together with details of the structures and functions of the embodiments, the disclosure is illustrative only and changes can be made in detail, especially in matters of shape, size, and arrangement of parts within the principles of the disclosure to the full extent indicated by the broad general meaning of the terms in which the claims are expressed.

Depending on the embodiment, certain steps or methods described can be removed, other steps can be added, and the sequence of steps can be altered. It is also to be understood that the description and the claims drawn for, or in relation, to a method can include some indication in reference to certain steps. However, any indication used is only to be viewed for identification purposes and not as a suggestion as to an order for the steps.

What is claimed is:

1. A detecting system, comprising:
a logic unit configured to receive a health state of a power supply; and
a baseboard management controller (BMC) electrically connected to the logic unit, and the BMC is configured to detect a power input state of the power supply;
wherein after detecting the power input state of the power supply, the BMC is configured to transmit a signal to the logic unit, and the logic unit is configured to receive the health state of the power supply and send a feedback of the health state to the BMC after receiving the signal.

2. The detecting system of the claim 1, wherein the BMC is configured to read a power input signal from a register of the power supply through an inter-integrated circuit bus.

3. The detecting system of the claim 1, wherein the logic unit is configured to switch on the power supply, when the power supply is powered, and the logic unit is configured to read the health state of the power supply after a predefined time.

4. The detecting system of the claim 1, wherein the logic unit is a complex programmable logic device.

5. A detecting method, comprising:
detecting a power input state of a power supply through a baseboard management controller (BMC);
informing a logic unit to receive a health state of the power supply when the BMC detects the power supply is powered,
receiving the health state of the power supply; and
sending a feedback of the health state of the power supply to the BMC.

6. The detecting method of the claim 5, comprising reading a power input signal from a register of the power supply by the BMC through an inter-integrated circuit bus.

7. The detecting method of the claim 5, comprising switching on the power supply by the logic unit when the power supply is powered, and reading the health state of the power supply by the logic unit after a predefined time.

8. The detecting method of the claim 5, wherein the logic unit is a complex programmable logic device.

9. A detecting system, comprising:
a logic unit connected to a first power supply and a second power supply, the first power supply being a primary power supply and the second power supply being a backup power supply, and the logic unit configured to receive a health state of the second power supply; and
a baseboard management controller (BMC) connected to the first power supply, the second power supply and the logic unit, and the BMC being configured to detect a power input state of the second power supply;
wherein the BMC is configured to signal the logic unit to receive a health state of the second supply when the BMC detects that the second power supply is powered, and the logic unit is configured to send a feedback of the health state of the second power supply to the BMC.

10. The detecting system of the claim 9, wherein the BMC is configured to read a power input signal from a register of the first power supply through an inter-integrated circuit bus.

11. The detecting system of the claim 9, wherein the logic unit is configured to switch on the second power supply, when the second power supply is powered, and the logic unit is configured to read the health state of the second power supply after a predefined time.

12. The detecting system of the claim 9, wherein the logic unit is a complex programmable logic device.
